(19) United States
(12) Patent Application Publication
(10) Pub. No.: US 2008/0098359 A1
(43) Pub. Date: Apr. 24, 2008

(54) Manipulation of trace sessions based on address parameters

(76) Inventors: Ventsislav Ivanov, Sofia (BG); Georgi N. Mihailov, Pleven (BG)

Correspondence Address: SAP/BLAKELY, 1279 OAKMEAD PARKWAY, SUNNYVALE, CA, 94085-4040, US

(21) Appl. No.: 11/540,364

(22) Filed: Sep. 29, 2006

(51) Int. Cl. G06F 9/44

(52) U.S. Cl. 717/128

(57) ABSTRACT

A method and apparatus for manipulation of trace sessions based on address parameters. An embodiment of a method includes receiving a request for a performance trace session for a computer application. A parameter is generated to designate the performance trace session. A call is received to an address of the computer application, where the call includes the generated parameter. A trace session is opened in response to the call to the address and the parameter.

### TECHNICAL FIELD

Embodiments of the invention generally relate to the field of computer systems and, more particularly, to a method and apparatus for manipulation of trace sessions based on address parameters.

### BACKGROUND

In the operation of a computer application, it may be necessary to determine the cause of system errors or poor performance by performing a performance trace. For example, an incorrect result may be provided by the application, the application may require excessive execution time or memory consumption, or the application may otherwise provide operate in an inadequate manner. The result provided by the computer application isn't always helpful in determining what may have occurred in the operation of the computer application. In such circumstances, a performance trace will record the activities of the system during the operation of the application, which may assist in identifying the source of the problem.

However, the use of traces in complex server systems may create certain problems because of the large, distributed nature of the system. In such a large system, it is extremely likely that the system will be actively working, and there will other users performing operation.

Thus, in a large system it can be expected that there will be multiple users at almost all times, and the operations of the multiple users may then overlap. For trace operations, it is important that traces of different users do not interfere with each other. If there is interference, then the data collected may be of any use in evaluating the application that is being evaluated.

### SUMMARY OF THE INVENTION

A method and apparatus for manipulation of trace sessions based on address parameters.

In one aspect of the invention, a method includes receiving a request for a performance trace session for a computer application. A parameter is generated to designate the performance trace session. A call is received to an address of the computer application, where the call includes the generated parameter for the performance trace session. A trace session is opened in response to the call made to the address and the generated parameter.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is an illustration of an embodiment of a use of an application address to initiate a trace session;

FIG. 2 illustrates an embodiment of a process for enabling a trace of an application;

FIG. 3 is an illustration of an embodiment of a process for starting and ending a trace;

FIG. 4 is an illustration of an embodiment of an architecture of a trace system;

FIG. 5 is an illustration of components of an embodiment of the architecture of an end to end trace system;

FIG. 6 illustrates an embodiment of a trace system;

FIG. 7 is an illustration of an embodiment of an administration system that implements end to end traces; and

FIG. 8 is an illustration of a computer system that may be utilized in an embodiment of the invention.

### DETAILED DESCRIPTION

Embodiments of the invention are generally directed to manipulation of trace sessions based on address parameters.

As used herein, a “trace” or “performance trace” is a process for obtaining data regarding the operation of a computer application. A “trace” includes a method to check the functioning of a computer program by obtaining the values of the variables used by the application in operation.

As used herein, an “end to end trace” is a trace that involves an application operating in multiple systems.

As used herein, an “administration system” means a system for administration of a server. The duties of an administrator include the operation of traces of computer applications. An administration system includes the NetWeaver Administrator (NWA) of SAP AG, which is a web-based tool that provides an interface for the SAP NetWeaver system.

As used herein, a “cluster of servers” is a group of independent servers running operating collectively as a single system. In general, a cluster appears to a client as a single server instance.

As used herein, “managed bean” or “MBean” is a Java program object to manage a resource, such as an application, a service, a component, or a device.

As used herein, a “URL” or “uniform resource locator” is an HTTP (Hypertext Transfer Protocol) address that specifies a resource on the Internet. A URL for an Internet resource instructs a browser program regarding where to the Internet resource.

In an embodiment of the invention, a system manipulates a trace session for a computer application using address parameters. In a particular example, the system generates parameters for the trace of an application, the parameters to be appended to a URL (uniform resource location) for the application. A trace session is initiated using the URL and the generated parameters. In an embodiment, the parameters may designate the type of performance trace to be run and may identify the system or systems to be subject to the trace. In an embodiment, a call to the URL of a computer application using one or more generated parameters will separate a trace session from other calls to the computer application.

In computer operations, an application may not operate properly and may require tracing. However, in a busy, complex it generally is not possible to engage in a trace operation without regard to the activities of other users on the system. On productive systems, as opposed to test systems, a slowdown of response or crashes of application resulting from trace operation can lead to significant problems for the overall operation of the system.

Because of this, the operation of traces for a system requires care to minimize the effect on productive operations. In an embodiment of the invention, special parameters in a URL may be utilized by users to commence a trace session for current user work without interference to other users.

In an embodiment of the invention, the choice of special parameters in URL can provide for initiation of a trace session for a current user activity. In an embodiment, different kinds of traces can be started depending on the generated parameters. In an embodiment, starting a trace session for one user on a system by calling the URL for an application and the generated parameters for the trace session will not significantly affect the work of the users. In addition, an embodiment of the invention makes it possible to run trace sessions for different users simultaneously in whole or in part.

In an embodiment of the invention, in order to initiate a trace session, a call is made to the URL for the computer application, which includes parameters that have been generated to designate the trace session. The use of the parameter allows the collection of data without interfering with any other user session. If the parameters are not used, then the separate sessions can affect the operation of each other, but multiple initiated traces sessions utilizing generated parameters to distinguish each session do not affect each other.

In general, if a URL for a particular application is called without any parameters, then multiple users can engage operations for the same application at the same time. However, as a result the operations in the simultaneous sessions can affect each other. For example, if a first user modifies data values, then the second user will access the modified data values. However, for traces it is important that operations remain separate. The effects of multiple users may make it difficult or impossible to determine the how the operations occurred, and thus the trace will not be effective in identifying an area of trouble in an application.

In an embodiment of the invention, a trace is also stopped by using the URL for the application together with the parameters generated for the trace session. In an embodiment, the use of the parameters will identify the appropriate trace to be stopped, without interference with other traces. In one embodiment, the trace is ended by a call to stop the trace. In another embodiment, the trace is ended by ending the trace session.

In an embodiment of the invention, a system automatically provides parameters to establish traces. For example, a trace manager that is responsible for managing traces may generate one or more parameters to establish a trace session. For each user, an HTTP session may be enabled together with one or more trace sessions that are associated with the HTTP session via a DSR (distributed statistics record) passport. In this manner, a trace session for a first user is separated from a trace session for a second user. Any data collected for the first trace session will relate only to the first trace session, and any data collected for the second trace session will relate only to the second trace session. Thus, in an embodiment of the invention a trace system automatically provides a mechanism for enabling separate traces of an application by different users, with each trace having no effect on the other.

In a particular embodiment of the invention, one or more URL parameters may be used to call a trace in an end to end trace system. In an embodiment of the invention, an end to end trace may be used to assist in finding problems in distributed systems. In an embodiment, the URL parameters may designate which systems will be involved in a trace. The systems involved in the operation of an application may be of any kind. In one example, the distributed systems may include a first system and a second system. The first system may be a Java system, such as a J2EE (Java 2 Platform, Enterprise Edition) environment (as described in the Java 2 Platform Enterprise Edition, v. 1.4 API Specification and related specifications). The second system may be, for example, a proprietary system such as the ABAP (Advanced Business Application Programming) system of SAP AG. However, embodiments of the invention are not limited to any particular number or type of systems, and may include the monitoring of other types of computer environments.

In a particular embodiment of the invention, a vendor may provide a customer with a solution that operates on separate systems, with such systems being in communication with each other. For example, a user call may go to a Java stack of a web application server on one system, and a call to ABAP stack of another system may then be made. If the application does not operate properly, it may be difficult to determine on which system the problem has occurred, or what exactly the problem is. In an embodiment of the invention, an end to end trace starts different traces on all of the systems in the cluster in order to provide data from all of the involved systems that may relate to the problem. In an embodiment of the invention, correlation objects are used to identify the path of a user activity and then to display which systems are involved. In an embodiment of the invention, an end to end trace may use common trace format for storing trace data to assist in troubleshooting. (The common format may be referred to as common performance trace, or CPT.) The resulting trace data is stored in a database of a central system, which may be in the common trace format, where the data can be analyzed in multiple different ways.

In an embodiment of the invention, data for a performance trace is correlated to connect the data to the trace. In an embodiment, an element which may be referred to as a “passport” is sent with communications to identify and distinguish the end to end trace. In an embodiment, the passport includes a unique correlation ID that is used to correlate data for any particular performance trace. In an embodiment, the passport is a DSR (distributed statistics record) passport, where distributed statistics records are records to enable monitoring of the performance of a system. The DSR passport may be created on the first system on which tracing begins, and distributed with the trace such that the correlation ID is passed to each system. In an embodiment, the distribution of the passport may be utilized in multiple different types of systems, including, for example, J2EE systems and the SAP ABAP system. In an embodiment of the invention, an end to end trace of a computer application is implemented by correlating the traces in each system to allow formation of an overall trace result, with a passport being sent together with every communication for the end to end trace in the format that is appropriate for each traced system.

In an embodiment of the invention, the process of correlation varies with the system and tracing process. In an embodiment of the invention, correlation objects may be used to identify the path of a user activity and then to display which systems are involved. In JARM (Java Application Response Time Measurement) and SQL traces an end to end trace may operate with the assistance of a trace correlator object that is used to analyze trace records that originate from different software components.

A correlator defines a semantic group, which may be used to assist in understanding how traces relate to each other. In an example, a user activity for an application may trigger several requests that are processed by multiple different components. In an embodiment, a system will run an application on multiple systems, collect traces from each of the systems, and merge and analyze the traces. In this process, abstract correlated objects are introduced to allow end-to-end analysis of the user objects, which may be processed by many components running on various different host systems. The correlation objects are used to combine trace data from different sources, and may be serialized over a network and transferred via the appropriate metadata for each communication protocol. The correlators for each trace may include, for example, a passport identification, a user name (to attach the trace to a particular user), and a transaction name (to identify a particular transaction, such as particular run of an application).

In an embodiment of the invention, a performance trace system includes an administration system, the administration system having duties that include the implementation and management of end to end traces. The administration system includes modules for the operation of end to end traces, includes modules for the import of trace data from each type of system. The administration system further includes a JMX (Java management extensions) provider to provide JMX interfaces. JMX is utilized to instrument, manage, and monitor server components, including services, interfaces, and libraries, and computer applications.

In an embodiment of the invention, a data element, which may be referred to as a “passport”, is sent with communications to identify and distinguish the end to end trace. In an embodiment, a common identifier is needed for traces to connect the traces to a particular trace session. In an embodiment, the passport is a DSR passport, where distributed statistics records are records to enable monitoring of the performance of a system. The DSR passport may be created on the first system on which tracing begins, and distributed with the trace. In an embodiment, the distributed reports may be utilized in multiple different types of systems, including, for example, J2EE systems and the SAP ABAP system. In the embodiment, the passport is sent together with every communication for the end to end trace in the format of each traced system. For example, in ABAP the passport is a specific correlator object existing in an ABAP word and which corresponds to a particular a new LUW (logical unit of work). In the Java stack the passport is maintained by the DSR service and corresponds to a security session. The passport may include a GUID, which is a unique identifier or key for the trace session. If other types of systems are involved in a performance trace, the passport would be supported by as required in the system.

In a possible example, a user may run a process on multiple systems and determine that an error or other issue has arisen with regard to such process. The user then may select the systems to be traced from an administration system and start a new trace activity. The user may further select the types of traces to be run. The user then runs any relevant test cases, and each monitored system traces all actions within the trace request. The user may then stop the trace activity. The system then collects and merges the trace data from all of the selected systems to allow for analysis of the collected data. The resulting combine result then may be viewed by the user.

In an embodiment of the invention, a system may optionally include an HTTP proxy for use in collecting client statistics. In an embodiment, an HTTP proxy listens to requests from a browser to the system in order to measure time that is lost in network communication. If an HTTP proxy is used, client data is uploaded to the administration system. In an example, an HTTP proxy application may be installed on a system, such as specifically in a computer on which a browser is opened for the operation of a trace. The proxy may be used to measure client rendering and network traffic after a response from a server is returned. In this example, resulting end data then may include HTTP requests with duration time values for rendering time, network time, and server time.

In an embodiment of the invention, a monitored system includes such import modules as are needed to generate and transfer trace data for the relevant systems. For example, a J2EE monitored server includes an MBean (managed Java bean) server, and utilizes an MBean to provide trace models. An MBean is a Java object that represents a manageable resource, such as an application, a service, a component, or a device. In an embodiment of the invention, an ABAP monitored server includes a CCMS (Computer Center Management) agent and an administration system includes a CCMS system. CCMS refers to the ABAP based monitoring infrastructure of SAP AG. Other types of servers may include other types of import modules needed to obtain and transfer data collected in trace operations.

In an embodiment of the invention, an end to end trace result is generated from the correlated traces of multiple different systems. The trace result may be represented as a display for a user. The display of trace results may include display that illustrates how the time was used in the application operation and how it was distributed among different application elements.

In an embodiment of the invention, a user interface may be provided for a user to request traces and to obtain the results for analysis. In an embodiment, the user interface may utilize a web-based system, and may operate in conjunction with a web-based administration unit. This may be implemented as, for example, a Web Dynpro application in a NetWeaver administrator plug-in. However, embodiments of the invention are not limited to any particular interface process for a user.

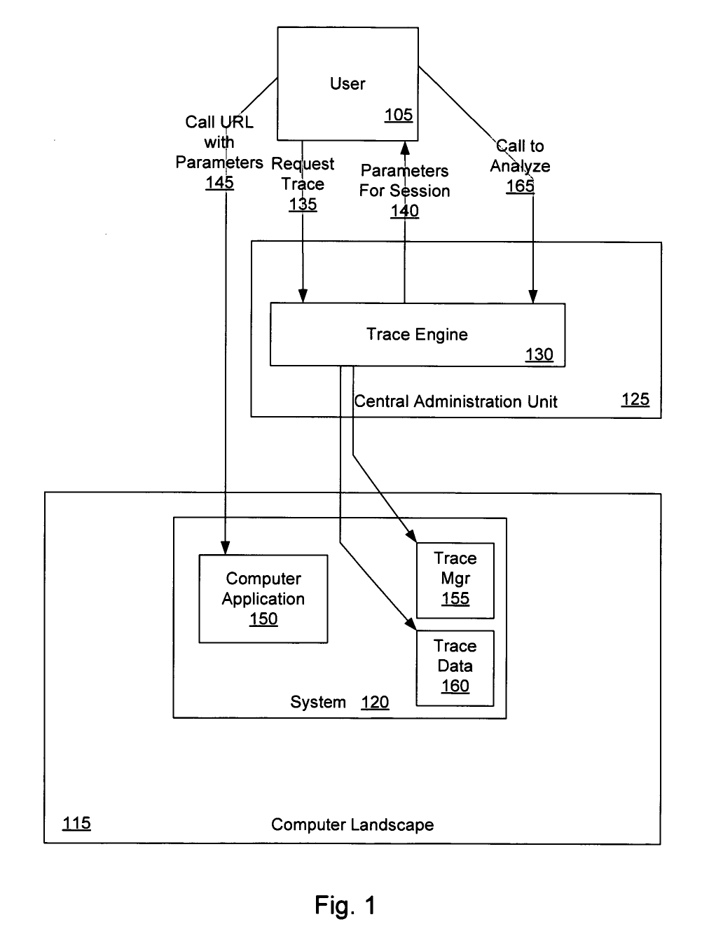

FIG. 1 is an illustration of an embodiment of a use of an application address to initiate a trace session. In this illustration, user 105 may initiate a computer application 150. The user 105 may be an individual in certain circumstances, or may be an automated unit or system. In an embodiment, the computer application 150 may operate in a computer landscape 115 that may include a system 120. In an embodiment, an HTTP session is established for user 105. If the computer application does not operate properly for any reason, it may be necessary to conduct a performance trace of the computer application.

In an embodiment of the invention, a central administration unit 125 includes a trace engine 130 that may be used to provide a trace of an application running on system 120. In an embodiment of the invention, if the user 105 requests a trace 135, the trace engine 130 generates parameters for a trace session 140, where a trace session is an HTTP session that has been designated for a trace. In addition, the trace engine may generate a trace manager 155 to collect trace data. In an embodiment of the invention, the user 105 may initiate the trace session by making a call to the URL for the application, with the call including the parameters generated by the trace engine 130.

Upon initiating the trace, trace data will be generated for the system 120, shown here as trace data 150. In an embodiment, the parameters used to call the application may determine what types of trace data will be collected. In an embodiment of the invention, the trace data 160 may utilize a common trace format (CPT—common performance trace), or may be converted to such a common trace format. The user then may make a call to analyze the collected trace data 165.

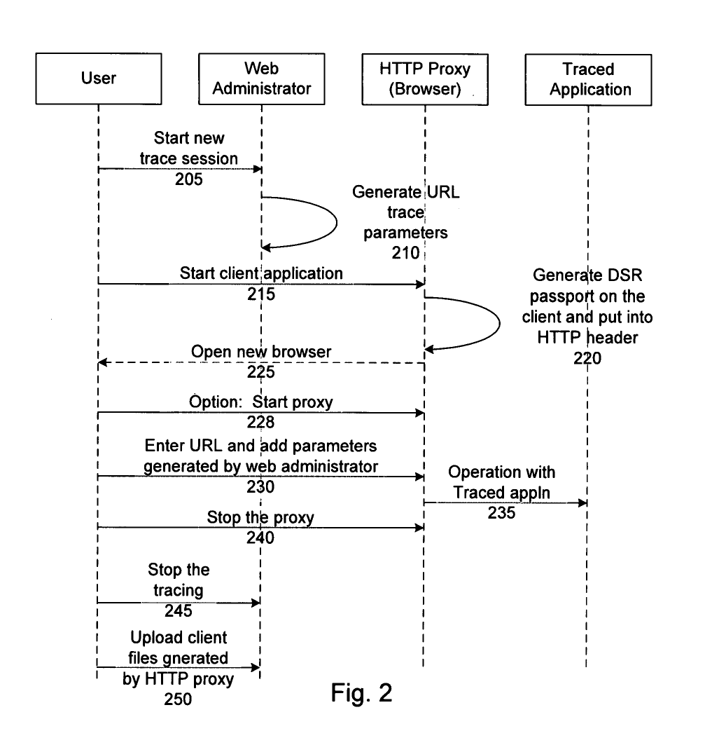

FIG. 2 illustrates an embodiment of a process for enabling a trace of an application. In this illustration, a user who is operating an HTTP session starts a new trace session 205. In response, a web administrator generates URL trace parameters for the trace session 210. The utilization of the URL parameters enables the trace session to be implemented without interference with any other trace session. The user may then start the client application 215. In response, an HTTP proxy may then generate a DSR passport on the client and put the passport into the HTTP header 220. A new browser may then be opened for the user 225. The user may enter the URL and add the parameters generated by the web administrator 230. This may be followed by an operation with the traced application 235.

At the conclusion of the trace operation, the HTTP proxy may be stopped 240 and the tracing process is stopped 245. The client files generated by the HTTP proxy then are uploaded to the web administrator for analysis of the trace results 250.

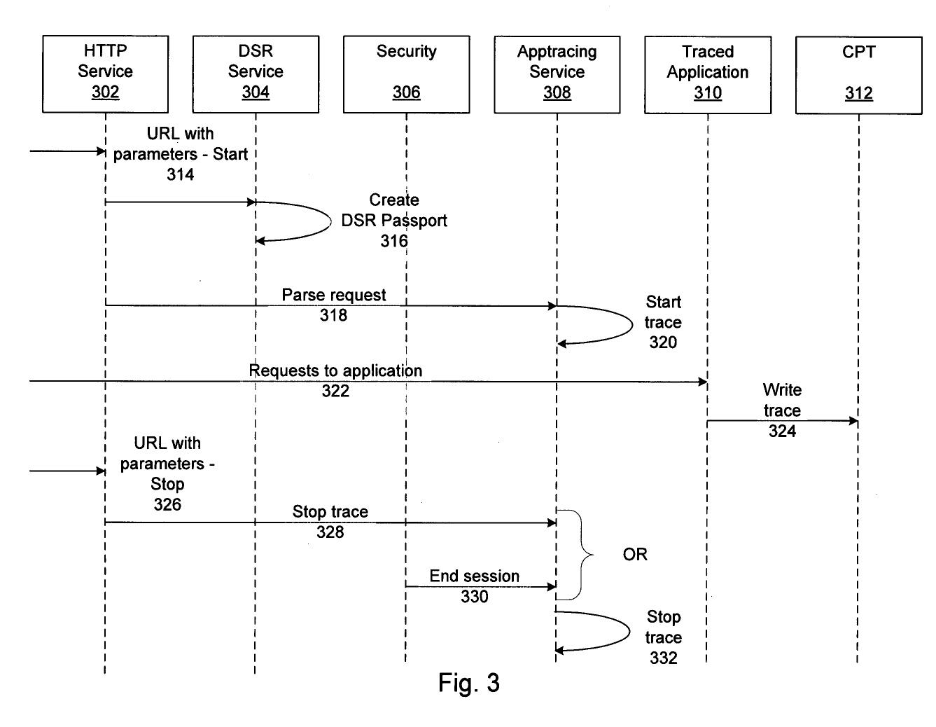

FIG. 3 is an illustration of an embodiment of a process for starting and ending a trace. In this illustration, the initiation of the trace is shown via operations of an HTTP service 302, a DSR service 304, a security element 306, an application tracing service 308, the traced application 310, and a CPT (common trace protocol) system 312. In an embodiment of the invention, an HTTP service receives a URL with parameters for a particular trace session. The URL and parameters may be received from a user who is establishing a trace session to perform a trace on a computer application. The parameters may, for example, be the parameters generated in the illustration provided by FIG. 2. In an embodiment of the invention, the URL and parameters may initiate an end to end trace, which may utilized a correlation object to correlate different trace elements from different systems. For example, a DSR service may generate a DSR passport. For a particular user, an HTTP session may be enabled together with one or more trace sessions that are associated with the HTTP session via the DSR passport.

In this illustration, the request for a trace is parsed 318 by the application tracing service 308, and the trace is started 320. In the process of the trace, any requests are made 322 to the traced application 310. The traced application then provides the trace data to be written 324 to storage, which in this case is the CPT system 312.

When the trace is completed, the requisite URL with parameters is received for a stop 326 at the HTTP service 302. The HTTP service may make a call to the application tracing service 308 to stop the trace 328. In another embodiment, the security element may make a call to the application tracing service 308 to end the trace session 330. The application tracing service will stop the trace 332, which may allow the requesting user to obtain the relevant trace data and examine the outcome.

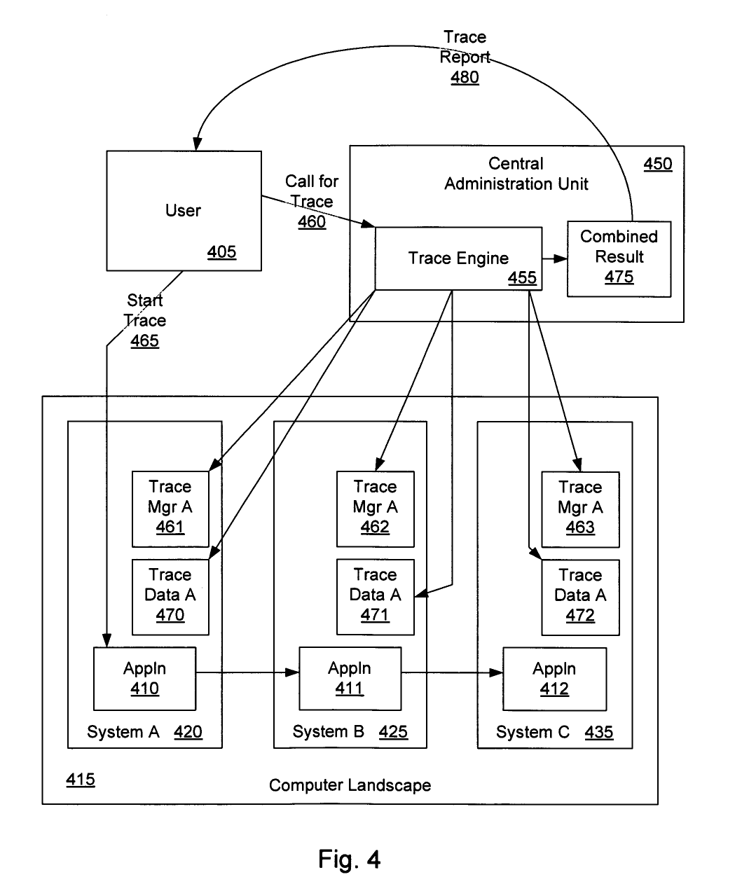

FIG. 4 is an illustration of an embodiment of an architecture of a trace system. In this illustration, user 405 may operate a computer application in a computer landscape. The user may be an individual in certain circumstances, or may be an automated unit or system. In an embodiment, the user 405 may call a computer application may in a computer landscape 415 that may include multiple different systems of different types. For example, in the computer landscape 415, the user may call a computer application A 410 in a system A 420. In operation, computer application A may then call computer application B 411 in system B 425, which, for example, may call computer application C 412 in system C 435. Thus, in this example, the operation of a computer application operates in systems A, B, and C. If the computer application does not operate properly for any reason, it may be necessary to conducts traces of the computer application as applied in each of the affected systems.

In an embodiment of the invention, a central administrator unit 450 includes a trace engine 455 that may be used to provide a trace of each of the affected systems. If the user 405 calls for a trace 460 in each of the systems, the trace engine 455 takes action to initiate a trace on each of the affected systems. In an embodiment, the trace engine 455 opens a trace manager in each system to collect data, as shown in FIG. 1 as trace manager A 461 in system A 420, trace manager B 462 in system B 425, and trace manager C 463 in system C 435. The method of initializing the trace may vary in different circumstance, and different types of traces may be requested depending on the circumstances and the needs of the user 405. In an embodiment, the trace is started by the user 405 making a call to computer application A 410. In an embodiment, the call includes a URL for the application with the addition of parameters established for the performance trace.

Upon initiating the trace, trace data will be generated for each affected system, shown here as trace data A 470 for system A 420, trace data B 471 for system B 425, and trace data C 472 for system C 435. In an embodiment of the invention, the sets of trace data may utilize a common trace format (CPT—common performance trace), or may be converted to such a common trace format. In an embodiment of the invention, the trace engine 455 will combine the sets of trace data into a combined trace result 475. The combined trace result 475 then may be used to generate a trace report 480 for analysis by system user 405.

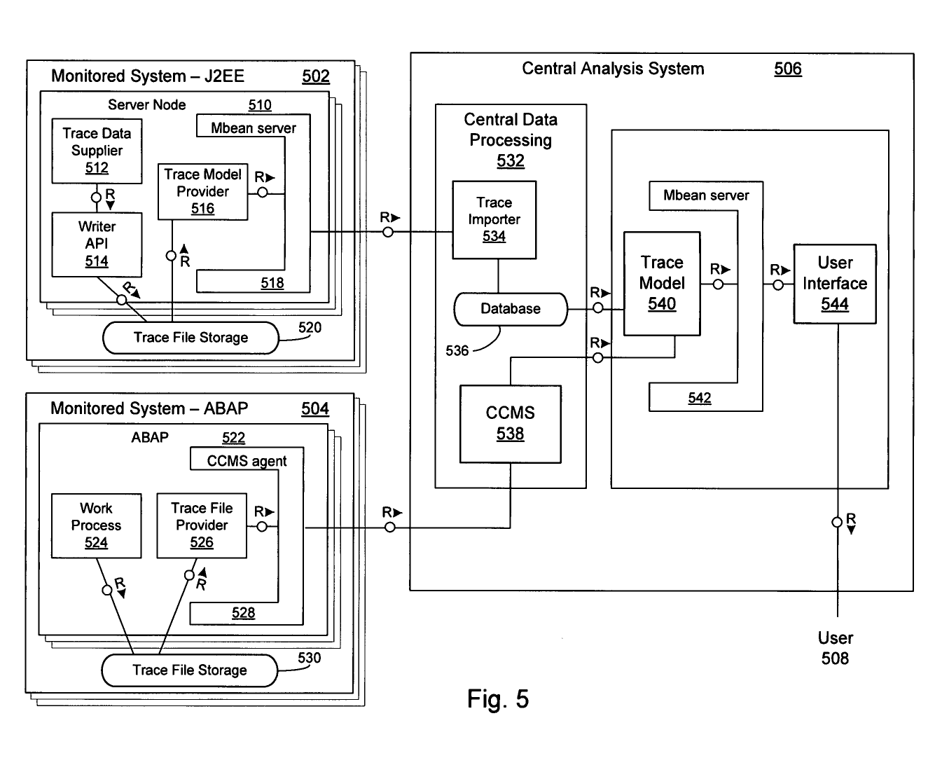

FIG. 5 is an illustration of components of an embodiment of the architecture of an end to end trace system. FIG. 5 and the other figures herein are provide to illustrate embodiments of the invention, and do not contain all elements that may be present in a system or apparatus. In this illustrated example, a central analysis system 506 (which may be part of an administration system) will provide trace support for one or more J2EE monitored systems 502, each one of which may include one or more server nodes, and one or more ABAP monitored systems, each one of which may include an ABAP server. In an embodiment, in tracing a J2EE system utilizes instrumented code that creates a trace data supplier 512 to write performance trace data via an API 514 (application program interface), which may be an API utilizing a common trace format. In an embodiment, the performance trace data is written to a temporary storage, such as the trace file storage 520 for the J2EE monitored system 502. The system may further include a trace model provider, which may be implemented as an MBean registered to the local system MBean server 518 and which thus allows accessing the trace data from the central analysis system 506.

In an embodiment of the invention, an ABAP monitored system 522 includes a CCMS agent 528 that allows CCMS 538 to access trace data for the local ABAP system, which is collected by a work process 524 and storage in a temporary storage, shown as trace file storage 530. The use of CCMS functional modules allows retrieval of ABAP traces.

The central analysis system 506 includes a central data processing module 532 to retrieve trace data from the local systems, such as the J2EE monitored system and the ABAP monitored system. The central data processing system 532 may import mechanisms to obtain the trace data from the local systems, such as a trace importer module 534 to obtain trace data from J2EE systems, with the data then being stored in a database 536, and a CCMS system 538 to obtain trace data from ABAP systems. If traces are performed in other types of systems then the central analysis system 506 may include other types of import mechanisms. After being retrieved from a local server, such traces may be integrated into a central trace model 540 by retrieving the trace data from the database 536 and by performing RFC calls to CCMS system 538. The trace model 540 enables the end to end trace data, allowing for access to the trace data in a convenient manger for a user interface 544 via an MBean server 542, providing merged data from Java and ABAP sources, and providing for data filtering and aggregation of the data.

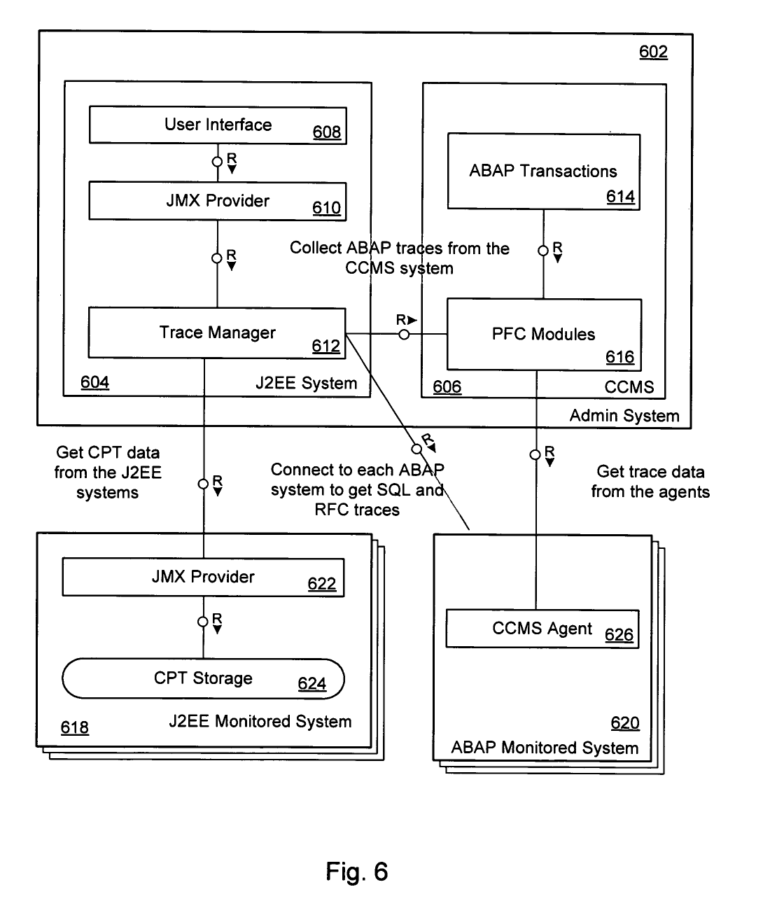

FIG. 6 illustrates an embodiment of a trace system. In this illustration, an administration system 602 is responsible for implementing an end to end trace of a computer application, where the computer application includes components running on multiple systems. For example, in the implementation of a trace there may be one or more J2EE monitored systems 618 and one or more ABAP monitored systems 620. In an embodiment, the administration unit is a Web-based unit. The administration system 602 may include a J2EE system element and a CCMS element 606. Within the J2EE element 604 of the administration system 602 there may be a user interface 608, which may include, but is not limited to, a Web Dynpro application. The user interface 608 is coupled with a JMX provider, which may provide for messaging. The J2EE element 604 then includes a trace manager 612 to manage operations. The administration system 602 further includes a CCMS system, including a module for ABAP transactions 614 and PFC modules 616.

In an embodiment of the invention, the trace manager 612 is to generate one or more parameters for a trace session upon request from a user. In an embodiment, the parameters uniquely identify the trace system such that the trace session can be run without interference with other operations.

In the illustrated embodiment, the trace manager 612 of the administration system 602 is coupled with each J2EE monitored system 618 via a JMX provider 622 to obtain Java system trace data. The J2EE monitored systems each include a storage for trace data, which may include a common trace format data storage shown as the CPT storage 624. The administration system is further coupled with each ABAP monitored system 620 to obtain ABAP trace data. Each ABAP monitored system includes a CCMS agent 626, which provides for communication with the CCMS system 606 of the administration system 602. In an embodiment, the format of the ABAP system traces may vary and may require translation to a common trace format, such as CPT.

In an embodiment of the invention, the administration system is to initiate a trace on each affected J2EE monitored system 618 and ABAP monitored system 620. Each such system will trace the application operation, and collect the relevant trace data. The administration system 602 via the trace manager 612 will gather the trace data from each system, correlate the data together, and create a result reflecting an end to end trace of the application.

In an embodiment of the invention, the trace is started by calling a URL for the relevant computer application, together with the one or more parameters that have been generated by the trace manager for the trace session. In an embodiment of the invention, the trace will also be stopped by called the URL and the generated parameters.

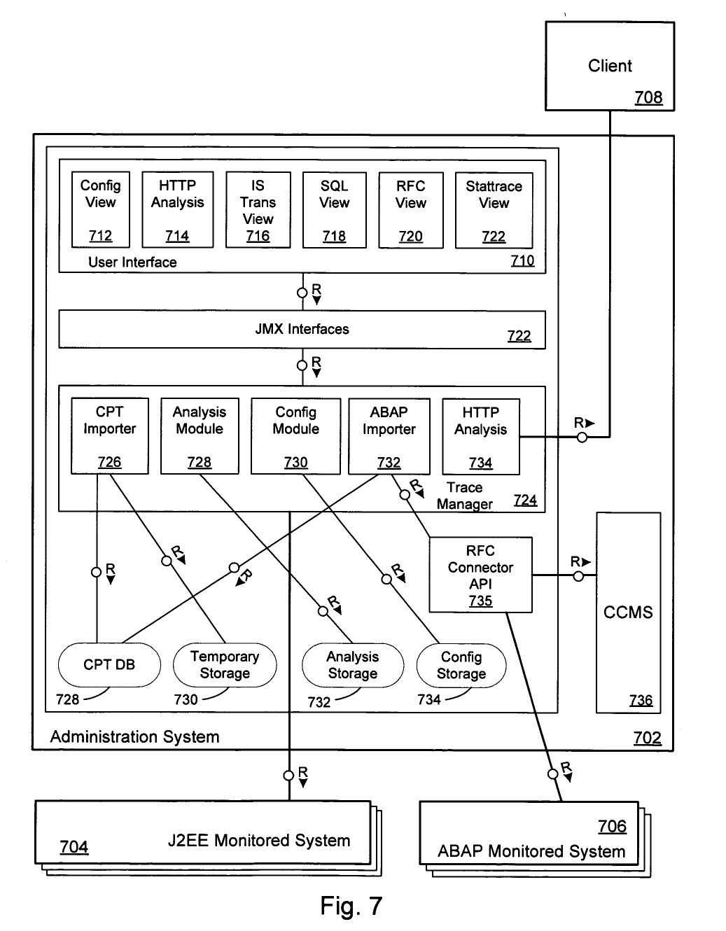

FIG. 7 is an illustration of an embodiment of an administration system that implements end to end traces. The illustrated trace system provides details for an embodiment of system that may include the elements illustrated in FIG. 6. As illustrated, an administration system 702 is responsible for trace operations for a client 708 operating an application on one or more J2EE monitored systems 704 and one or more ABAP monitored systems 706. The J2EE monitored systems are coupled with a trace manager 724, and the ABAP monitored systems 706 are coupled to a CCMS system 736 via an RFC connector API 735. The API 735 is a proxy of the RFC function modules and creates a general framework for connection to the ABAP systems. The API connects to the CCMS system on administration system and to all ABAP monitored systems.

In this illustration, the trace manager 724 includes a number of modules for trace operations. The trace manager may include a configuration module 730, which contains methods for starting and stopping trace activities, and that maintains general information about the trace activities (such as name, start and end data, and filters) in a configuration storage 734. The modules may include an ABAP importer 732 to import the ABAP trace data via the RFC connector API 735 to a database 728, which may be a CPT (common performance trace) database. In addition, the trace data from the J2EE monitored systems 704 is stored in a temporary storage 730. The trace manager further includes a CPT importer 726, which obtains the trace data from the J2EE monitored systems 704 stored in the temporary storage, and imports the data to the database 728.

In one embodiment, the trace manager 724 may include a HTTP analysis module. If an HTTP proxy is used on the client side 708, then several XML files will be generated. These files are uploaded to the administration system 702, and, with the help of a responses.trc file that is generated by the HTTP service, the HTTP analysis is generated and imported to the database 728.

After the trace is stopped, the trace data is collected from the monitored system and imported to the database 728. In an embodiment, this data may then be analyzed by the analysis module and may be stored in a separate analysis storage 732.

Also illustrated are the JMX interfaces 722 to provide the link between the trace manager 724 and a user interface 710, which may include a Web Dynpro application. Contained within the user interface may be multiple views for the user to perform traces and analyze results, including a configuration view 712, an HTTP analysis view 714, an IS (Introscope) transactions view 716 a SQL view 718, an RFC view 720, and a Stattrace view 722.

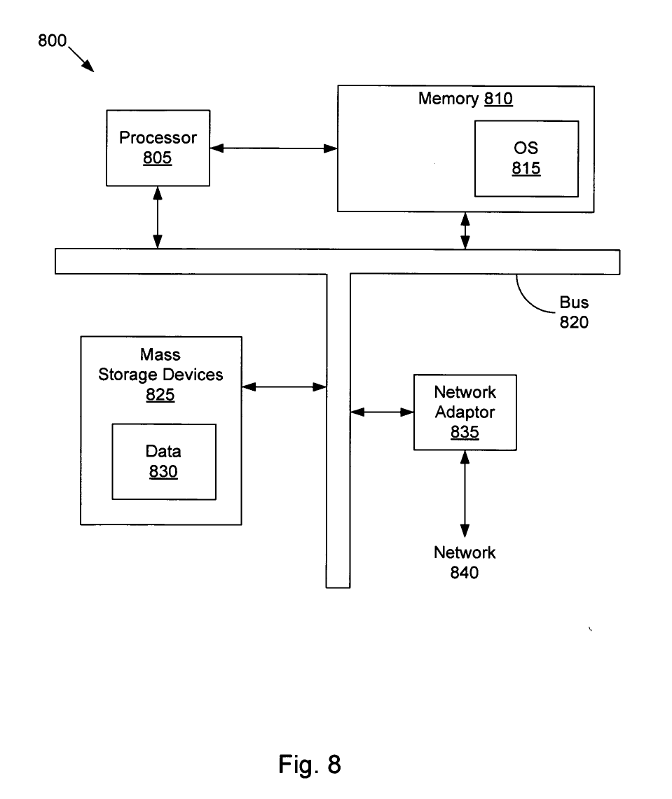

FIG. 8 is an illustration of a computer system that may be utilized in an embodiment of the invention. FIG. 8 may represent a system on which an application is run, or another portion of a server system. As illustrated, a computing system 800 can execute program code stored by an article of manufacture. The computing system illustrated in FIG. 8 is only one of various possible computing system architectures, and is a simplified illustration that does include many well-known elements. A computer system 800 includes one or more processors 805 and memory 810 coupled to a bus system 820. The bus system 820 is an abstraction that represents any one or more separate physical buses, point-to-point connections, or both connected by appropriate bridges, adapters, or controllers. The bus system 820 may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus, sometimes referred to as “Firewire”. (“Standard for a High Performance Serial Bus” 1394-1995, IEEE, published Aug. 30, 1996, and supplements thereto)

As illustrated in FIG. 8, the processors 805 are central processing units (CPUs) of the computer system 800 and control the overall operation of the computer system 800. The processors 805 execute software stored in memory 810. A processor 805 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 810 is or includes the main memory of the computer system 800. Memory 810 represents any form of random access memory (RAM), read-only memory (ROM), flash memory, or the like, or a combination of such devices. Memory 810 stores, among other things, the operating system 815 of the computer system 800.

Also connected to the processors 805 through the bus system 820 are one or more internal mass storage devices 825 and a network adapter 835. Internal mass storage devices 825 may be or may include any conventional medium for storing large volumes of instructions and data 830 in a non-volatile manner, such as one or more magnetic or optical based disks. The network adapter 835 provides the computer system 800 with the ability to communicate with remote devices, over a network 850 and may be, for example, an Ethernet adapter.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various processes. The processes of the present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Portions of the present invention may be provided as a computer program product, which may include a computer-readable medium having stored thereon computer program instructions, which may be used to program a computer (or other electronic devices) to perform a process according to the present invention. The machine-readable medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/machine-readable medium suitable for storing electronic instructions. Moreover, the present invention may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

What is claimed is:

1. A method comprising:
enabling trace mode;
generating an address with one or more parameters to designate a performance trace session;
receiving a call to an address of the computer application, the call including the parameter; and
opening a trace session in response to the call to the address and the parameter.

2. The method of claim 1, wherein the address is a URL (uniform resource locator) for the computer application.

3. The method of claim 1, wherein the parameter is automatically generated for the trace session.

4. The method of claim 1, wherein the computer application runs both on a first system and a second system, and wherein the performance trace session includes a performance trace of application operations on both the first system and the second system.

5. The method of claim 4, wherein the first system is a Java system.

6. The method of claim 4, wherein the second system is an ABAP (Advanced Business Application Programming) system.

7. The method of claim 1, wherein the parameter contains an identification that is unique to the trace session.

8. The method of claim 1, wherein the parameter designates a type of performance trace for the trace session.

9. The method of claim 1, further comprising receiving a request for a second trace session, and further comprising generating a second parameter to designate the second trace session in response to the request for the second trace session.

10. An administration unit comprising:
an interface with a user; and
a trace manager, the trace manager to automatically generate a parameter for a performance trace session in response to a request for a trace from the user, the trace session relating to a computer application;
wherein the trace manager is to initiate a trace session for the user in response to a call to an address of the computer application, the address including the parameter.

11. The administration unit of claim 10, wherein the administration unit is a Web-based tool.

12. The administration unit of claim 10, wherein the address of the computer application comprises a URL (uniform resource locator) of the computer application.

13. The administration unit of claim 10, further comprising a JMX (Java management extensions) provider unit, the interface being coupled with the trace manager via the JMX unit.

14. The administration unit of claim 10, wherein the computer application is to operate on a plurality of computer systems, the plurality of computer systems including a first system and a second system, the first system and the second system having different computer environments, and wherein the trace session is to include enabling a first trace of the first system and enabling a second trace of the second system.

15. The administration unit of claim 15, wherein the administration unit further comprises a first import module for trace data generated for the first system and a second import module for trace data generated for the second system.

16. A computer-readable medium encoded with a computer program having instructions, the instructions including:
receiving a request for a performance trace session for a computer application;
automatically generating one or more parameters to designate the performance trace session;
returning the generated parameters;
receiving a call to URL (uniform resource locator) of the computer application, the URL including the generated parameters; and
opening a trace session in response to the call to the address and the one or more parameters.

17. The medium of claim 16, wherein the computer application runs on a plurality of systems, and wherein the performance trace session includes a performance trace of application operations on each of the plurality of systems.

18. The medium of claim 16, wherein the one or more parameters include a designation of a type of performance trace to be performed in the trace session.

19. The medium of claim 16, wherein the one or more parameters include a designation of one or more computer systems to be subject to performance traces in the performance session.

20. The medium of claim 16, wherein the sequences of instructions further include instructions that, when executed by a machine, cause the machine to perform operations comprising:
receiving a request for a second performance trace session, and
generating a second parameter to designate the second trace session in response to the request for the second trace session.
